(19) United States
(12) Patent Application Publication
(10) Pub. No.: US 2016/0335992 A1
(43) Pub. Date: Nov. 17, 2016

(54) Drum Wah

(71) Applicant: Lawrence Jin-Sung Ham, Anna, TX (US)

(72) Inventor: Lawrence Jin-Sung Ham, Anna, TX (US)

(21) Appl. No.: 14/708,418

(22) Filed: May 11, 2015

(51) Int. Cl. G10D 13/02

(52) U.S. Cl. CPC G10D 13/028

(57) ABSTRACT

Here in lies the abstract of the drum wah. It is used to put pressure or lessen pressure on the sound membrane of a torn drum in real time, while the performer plays. It has two main components. It is made by attaching a metal beam into the inner walls of the tom drum, then attaching another metal beam on a hinge. This second beam, when tugged by a string, bends the pitch of the tom drum. The second component is the lever, which is controlled by hand pulling the string attached to the movable beam, creating a pitch change in the sound membrane of the tom drum. The lever is attached to the side of the drum and is hinged to control the string that pulls the moveable beam inside the drum.

### BACKGROUND

1. Field of the Invention

The present invention is directed to a drum that bends the pitch.

2. Description of the Related Art

Drums are usually tuned so that have a single pitch. The pitch of the drum is changed by tightening and loosening the head of the drum.

### SUMMARY

In one embodiment, the present invention, a drum wah lever that changes the tone of the sound off of the drum head.

### BRIEF DESCRIPTION OF THE DRAWINGS

FIG. 1 illustrates the device for applying pressure to the sound producing membrane.

FIG. 2 illustrates the device when it is placed within the drum for operation.

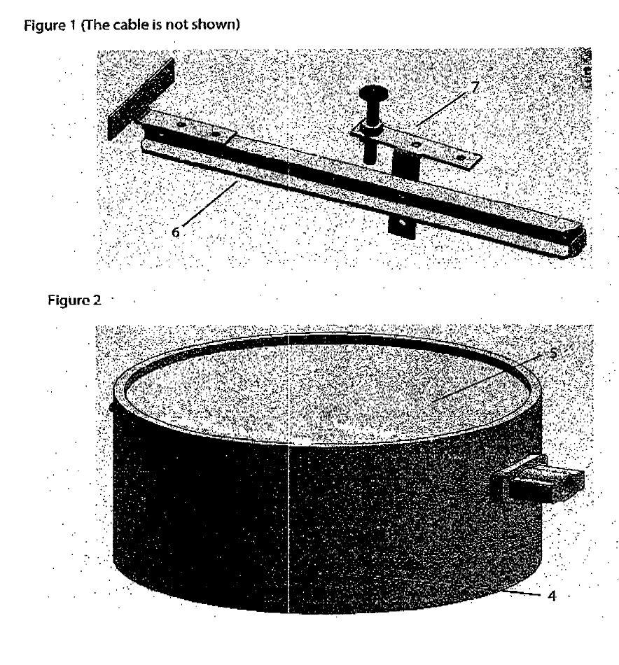

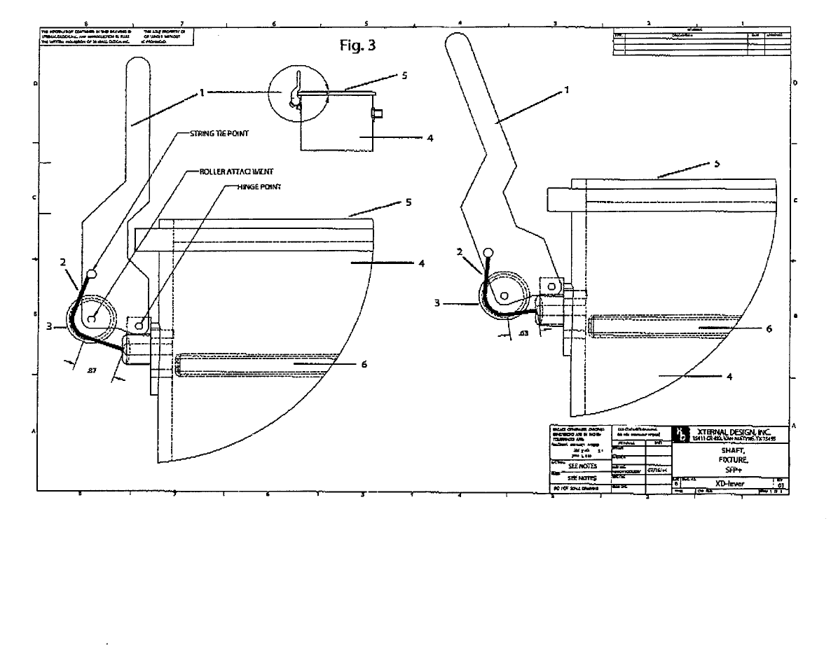

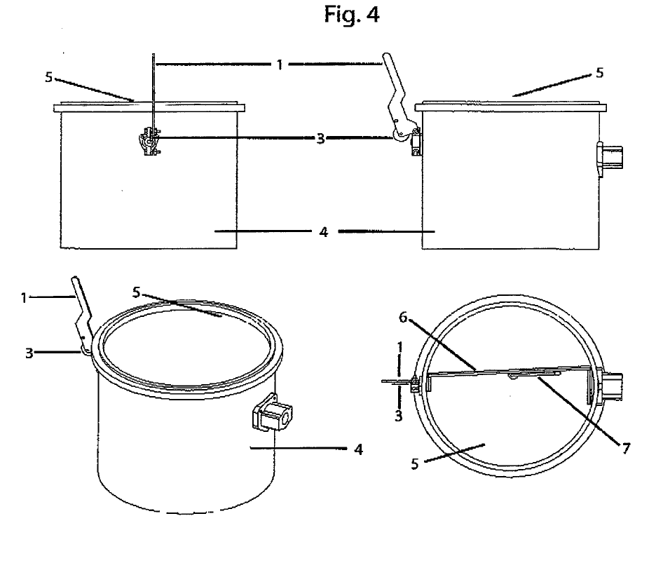

### DETAILED DESCRIPTION

A device for adjusting the tone and pitch drum, uses a pressure device adapted to engage the sound producing membrane of a drum and is operated by a tension mechanism. The tension mechanism may be operably engaged by a cable to provide pressure to the sound producing membrane of a drum. The cable may be of the form of a string or a wire to provide movement of the device applying pressure to the sound producing membrane of a drum. The cable may be moved by the musician manually or with the aid of a lever.

The movement of the wire or string applies and releases pressure on the sound producing membrane of a drum to provide a method of continuously varying the tone and pitch during play. The device shall be inside of the drum shell and operably moved by a cable and or lever that extends outside of the drum shell. As pressure is applied to the sound producing membrane the pitch increases. As pressure is withdrawn from the sound producing membrane the pitch decreases. The pitch may be varied by quickly applying and releasing pressure to the drum.

1. A drum and pitch adjustment device for a drum comprising:
a drum with a sound producing membrane;
a device for applying pressure to the sound producing membrane; and
a cable configured to the device for applying and releasing pressure to the sound producing membrane.

2. A drum and pitch adjustment device as described in claim 1 where a hand operated lever, located on the side of the drum, operates the cable.
